(19) United States
(12) Patent Application Publication
(10) Pub. No.: US 2003/0169461 A1
(43) Pub. Date: Sep. 11, 2003

(54) Document machine with programmable promotional advertising and information display, and related method

(76) Inventors: Gary Lin Gaebel, Vancouver, WA (US); Sara Lynn Leslie, Washougal, WA (US)

Correspondence Address: David C. Ripma, Patent Counsel, Sharp Laboratories of America. Inc., 5750 NW Pacific Rim Boulevard, Camas, WA, 98607, US

(21) Appl. No.: 10/094,553

(22) Filed: Mar. 8, 2002

(51) Int. Cl. G06F 17/60; H04N 1/32

(52) U.S. Cl. 358/442

(57) ABSTRACT

A document machine with a display screen and computer-controlled memory structure which has been configured to allow the scanning in, storing, and later presentation to users of the machine, of informational and promotional imagery.

### BACKGROUND AND SUMMARY OF THE INVENTION

This invention pertains to a document machine, such as a copier, a so-called MFP (multi-function peripheral) device, and various other document-processing machines which possess a document scanning capability. In particular, it relates to such a machine which includes, in addition to a scanning capability, an accessible internal memory and a display screen, and which has been configured, according to the invention, to allow scanning in of the contents of documents for later programmed informational and advertising display on its display screen to machine users. For the purpose of illustration herein, an embodiment of, and manner of practicing, the invention are described in the setting specifically of a document copying machine, usually just referred to as a copier. It should be understood that the features of, and advantages offered by, the invention, while described below in the environment of a copier, are offered equally well in the environments of the other kinds of document machines just generally mentioned.

Copiers, are widely installed for use in many different locations, and often in places where, for example, customers of businesses are offered the opportunity, if they so wish, to make copies of personal documents on a price-per-page basis. As an illustration, a large variety store which has many different departments, may have installed a number of individual copiers placed in different departments in that store for this very purpose. These copiers stand out in the open typically, and are usually intended to become profit generators for the business. Stand-alone copiers are also often installed in various employee places to allow employees access to document copying for business and other purposes. The activity of a copier user herein is also referred to as point-of-activity behavior.

The present invention proposes a modified form of copier (or other document machine of the types named above) which becomes an information delivery vehicle, and which is capable of expanding the potential profit-generating capabilities of such publicly-available machines by presenting sales or other promotional displays during times that a copier user is awaiting the completion of a copying job. Such a modified copier also furnishes another means for businesses to deliver announcements and messages, etc. to employees.

According to the present invention, an otherwise conventional copier of the type having an electronic display screen is modified, preferably at the time of manufacture, in a fashion that permits an operator, or a manager, in a business to access the copier's internal memory for the purpose of using the copier to do the following kinds of things: to scan in and record, as images, the contents of informational/promotional documents that might, for example, relate to special sales items in various departments of the business; to provide notices to employees; to create timing schedules for the presentation of recorded document images; to establish and modify sequences for the presentation of plural, successive images; to create a report list of stored images; to delete images; to allow copier users who see a display to print and take copies of selected displayed images; and other things limited only by imaginations of the operators.

A copier constructed and operating in accordance with the present invention does not need to be connected to any communication network, such as to the Internet, or to any internal business network. Rather it can be a versatile, stand-alone device, self-containing all uniquely programmed, presentable information.

In addition to permitting an operator/manager so to input image information for presentation to copier users, in a case where programmed presentations are pre-scheduled to occur in a certain fashion, it is also contemplated by the invention that a copier can be configured to become somewhat of a context-sensitive (or responsive) machine which presents information that specifically relates to certain kinds of triggering events, for example the particular activity of a user of the copier. As an illustration, it is entirely possible that an operator/manager might wish to present a particular display to any user who places into the copier for copying a document containing a certain word, phrase, or pattern of words, or even certain kinds of readily recognizable picture images of different things. And so, for example, in a context-responsive mode of operation, the machine might respond to a document containing the word “beverage” by presenting, after it recognizes the presence of that word, an image on the screen displaying various soft drink beverages which are “on sale” that day.

The invention also contemplates and enables the capability of configuring copiers not merely to display static images, but also to show animations if so desired.

These and other features and advantages that characterize the present invention will become more fully apparent as the description which now follows is read in conjunction with the accompanying drawings.

### DESCRIPTION OF THE DRAWINGS

FIG. 1 is a simplified schematic block representation of a document copier which has been configured to have the structure of, and to operate in accordance with, the present invention.

FIG. 2 illustrates an entry-level menu on a display screen in the copier of FIG. 1, which menu can be called up by an authorized manager/operator to gain access to implement various programming and operational instructions that will effectively control certain aspects of that copier's behavior.

FIG. 3 presents schematically a second-level menu on the same display screen, which secondary menu is made available after a manager/operator selects the “Manage Display Images” option presented in the screen menu shown in FIG. 2.

FIG. 4 is a block/schematic logic flow diagram generally illustrating the procedure engaged in by an operator/manager according to the invention to program the operation of the printer of FIGS. 1, 2 and 3 with respect to scanning in, storing and display-programming one or several new document images.

FIG. 5 is a fragmentary view which is somewhat like FIG. 1, except that here, shown within the fragmented block that represents the copier of FIG. 1, are internal blocks which reflect the memory status existing in that copier after an operator has programmed in certain documentary material for later display to a user of the copier.

FIG. 6 is a simplified, fragmentary, plan view of a portion of space in a large variety store having three different areas/departments in which the operators of the store have placed copiers that are there made available for use either by customers within certain departments, or by employees within an office that is accessible to employees in the store. Specifically depicted in this figure are two consumer departments in the store which sell, respectively, soft drinks and electronic gadgets. The third area shown represents a business office available to employees.

### DETAILED DESCRIPTION OF, AND BEST MODE OF PRACTICING, THE INVENTION

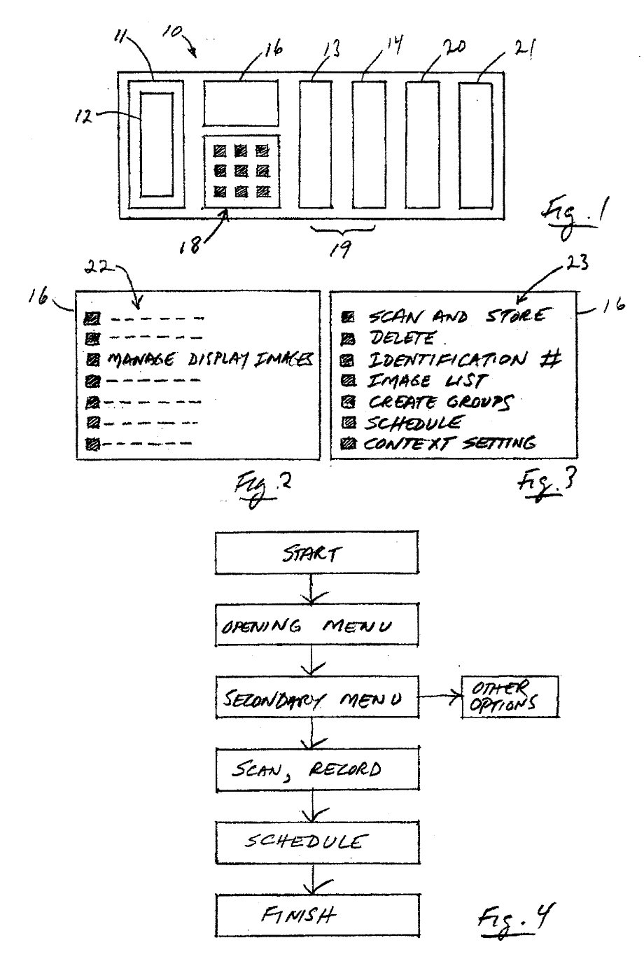

Turning now to the drawings, and referring first of all to FIG. 1, indicated generally in block form at 10 is a document copier which has been configured, and which operates, in accordance with the present invention. Copier 10 includes a document input station 11, a scanner 12 within station 11 which allows a user to place a document in the copier for copying, computer structure 13, an internal memory (or memory structure) 14, an electronic display with a screen 16, and programming controls externally available in the form of a key pad of push buttons 18. While machine 10 is shown with real (physical) programming buttons, it is entirely within the scope of the invention to employ a screen-display virtual keypad instead of a real one. Machine 10 could also, and just as well, be one equipped with a conventional full QWERTY keyboard with numeric keys, one equipped for voice-entry, or one equipped with any other kind of programming/communication entry interface. Push buttons 18 are also referred to herein as a manager-accessible programming control structure. Present also in copier 10 is display-enabling software, shown by a bracket 19, that forms an operative foundation for implementation and practice of the present invention.

In addition to the presences of the copier componentry so far mentioned, copier 10 further includes a print engine 20 which delivers hard-copy documents to a user at a printed-document output dispenser 21.

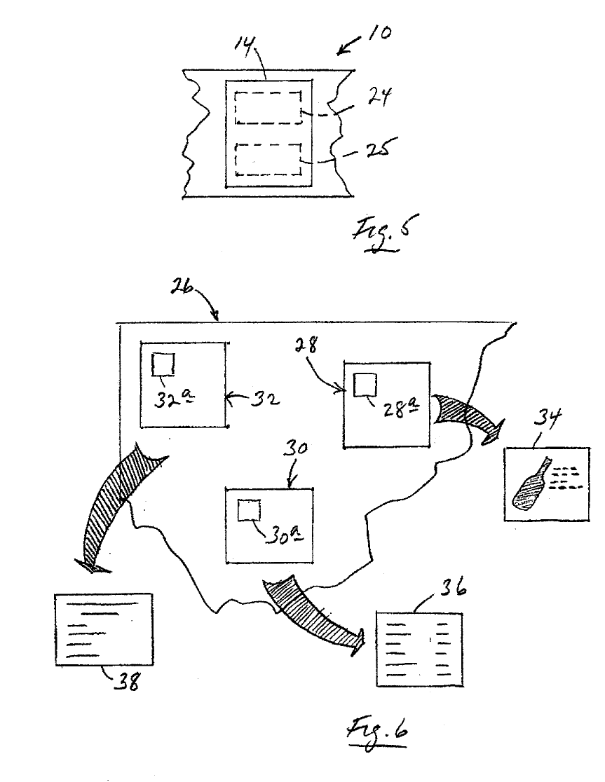

Looking now at FIGS. 2-5 inclusive along with FIG. 1, it is conventional for a manager or operator assigned to copier 10 in a business to have code access to the internal workings of the copier for gathering certain information from the copier. and for programming aspects of its behavior. This permitted activity defines herein an entry point, so-to-speak, for accommodating the programming of copier 10 to behave in accordance with the present invention. From a reading of the operational description now to be given herein, the flow of activity schematically shown in FIG. 4 will be quite apparent and understandable to those generally skilled in the art. Accordingly, no separate, detailed description of FIG. 4 is deemed necessary. Nor is it necessary to detail the precise software-implemented steps that can be used to realize the practice of the invention, inasmuch as those skilled in the art will readily draw upon their own preferences and experiences to define just how the detailed logic of behavior is desired to flow.

Such a manager/operator, once gaining access to the controls that will effect the operational configuration of copier 10, is presented typically with a first-level menu screen display, somewhat like that which is pictured schematically at 22 in FIG. 2. On the screen that is shown in FIG. 2, one of the selectable menu options is labeled “Manage Display Images”, and this is the option that leads into the operation of the present invention. Other options listed in menu 22 are not detailed here. They do not relate to practice of the invention.

Explaining now, with reference to the menu shown in FIG. 2, how copier 10 becomes prepared under the control of an accessing manager/operator to capture, store, display, delete or otherwise manage promotional and/or informational material, the manager, after gaining access to menu 22, selects the “Manage Display Images” option from the menu. Thereafter she or he is presented with a second-level menu 23 pictured in FIG. 3. What now specifically follows herein is a description generally regarding the inputting, scheduling and managing of certain selected display information in accordance with the specific offerings of menu 23.

To introduce new display information, the manager/operator places one, or several successive, document(s) over scanner 12, and issues an instruction essentially selected from menu 23, for the copier's internal memory, and the associated computer structure which is in the copier, to capture and store, as an image or images, whatever the informational/promotional content is in the document or documents so placed on the scanner. Other options made available in menu 23 are thereafter chosen appropriately to allow the operator/manager to designate just how the new, particular scanned-in document's content (or documents' contents) is (are) to be presented to a later user of copier 10. These other options include: selection of document identification numbers; selection of starting times and stopping times (time spans) for presentation; deletion of previously stored images at any time; organization of collections of images into running displays of successive images; listing already stored images; allowing a copier user to print a hard copy of a display image; and establishing a contextual setting for the printer to initiate display activity. The list presented in menu 23 in FIG. 3 is illustrative only—not exhaustive. The vertical logic flow pictured in FIG. 4 outlines behavior specifically related to selecting, scanning, storing and programming new images. The lateral branch shown extending from the right side of the block marked “SECONDARY MENU” is provided to emphasize the fact that a manager/operator, in the setting of programming in the new images, can also then access and implement other options.

At the completion of such an inputting, scheduling and managing operation, the operator simply closes out of the programming control operating phase with the copier, and the copier is then ready to behave in accordance with what the operator has instructed it to do, vis-a-vis presentation of the now-established programming for stored images. As was mentioned above, FIG. 4 generally shows the information flow logic that has just been described with respect to operator-programming of copier 10 to deal with new scanned-in images.

FIG. 5 which, as was mentioned earlier, is very much like FIG. 1, now shows two blocks 24, 25 which represent respectively, the stored document content material for display, and the managed scheduling for display that has been designed by the operator for handling and displaying the material represented by block 24.

Copier 10 is now configured to behave in accordance with the invention as a display device for the memorized document contents, and specifically to operate in a scheduled manner in accordance with the display schedule that the operator has designed.

Turning attention now to FIG. 6, shown generally at 26 is a fragment of a sales floor in a large variety store. Included within the overall business area represented by the fragmentary store showing in FIG. 6 are two specific consumer departments, or areas, for the selling of different kinds of goods, one being represented by a block 28, wherein soft drinks are sold, and another being represented by a block 30, wherein electronic gadgets are sold. Also pictured in FIG. 6 by a block 32 is a business office which is accessible to employees.

Shown by smaller blocks 28a, 30a, 32a within blocks 28, 30, 32, respectively, are stand-alone, independent copiers, like copier 10, which have been configured to present different scheduled displays of previously scanned-in documents. Pointing outwardly from each of blocks 28, 30, 32 in FIG. 6 are large shaded arrows which point toward simplified schematic representations of three different image displays which an operator/manager has programmed for display into copiers 28a, 30a, 32a. The large arrow emerging from block 28a points towards a soft drink special offering display, pictured at 34. The arrow pointing outwardly from block 30 aims toward a display 36 which announces and lists various electronic gadgets that are being offered at special sales prices. The large arrow which points outwardly and downwardly in FIG. 6 from office block 32 is aimed at a display 38 which contains an announcement to store employees that there is to be a specified company meeting.

According to a preferred manner of practicing the invention, the displays scheduled for the screens in copiers 28a, 30a, 32a run automatically at preset times, and are viewable whenever a user is employing these copiers, and awaiting the completion of a copying job. The specific displays which are presented can be changed independently and at will, and can thus be kept easily up to date in accordance with the wishes of the manager/operator. With regard to any particular promotional display that is presented to a user, the copier operator/manager may wish to offer the user the opportunity to look at, and/or print out for use, a copy of the displayed image. A printed-out copy can be used, as an illustration, as a sales purchase “discount coupon”. This is a selectable option easily offered by the methodology and structure of the invention.

Thus it will be evident how the structure and methodology of the present invention make the copiers that have been placed in areas 28, 30, 32 in store 26, or at least those copiers in departments 28, 30, potentially more commercially productive because of their respective displays of materials that may encourage a customer user of the copiers to take advantage of the displayed offerings. The specific displays presented can be tailored at will to track with the store events and offerings. The schedules associated with the renderings and presentings of the several displays are completely a matter of free manager/operator scheduling, and it should be understood that these three specific representative display image may each form part of a sequence of plural display images that has been organized into the copiers, again completely at the selection and free will of the programming manager/operator. No external network connection is present, and no “downloading” of display content is required from any such connection.

With this description of the operation of the invention, given in the context of static documents that have been scanned into a copier for display, and with these documents later presented according to some freely selectable schedule, it should be apparent how other kinds of displays and behaviors, such as an animation display, and/or a context response can be made to take place. For example, the copier in soft drink department 28 in store 26 might be programmed to watch for incoming documents put into its scanner by a user which make reference to soft drinks. On noticing such a reference, the copier could switch into a mode where it places a pre-scanned and pre-recorded soft drink promotional message on the display screen in copier 28a. It is also possible, for a copier to be armed, so-to-speak, to be proximity responsive, so that it awaits the arrival of someone in close proximity to switch from a sleeping or inactive mode, into an active display mode. Various other modes and types of display activity can readily be adopted—all of which come within the intended and understood scope of the present invention.

Also, it will be apparent how all of the structural and methodological features of the invention can be incorporated with other types of document machines of the kinds earlier mentioned herein.

Accordingly, while one embodiment of the invention (method and structure) has been specifically illustrated and described herein, and certain variations suggested, it is understood that other variations and modifications may be made without departing from the spirit of the invention.

I claim:

1. A document machine with selectively programmable promotional display capability comprising
a document input station,
a scanner operatively associated with said input station,
a display screen,
computer structure operatively interconnecting said input station, said scanner and said screen, and including memory structure,
manager-accessible programming control structure operatively associated with said computer structure, and
display-enabling software installed in the machine for access and use by said computer structure, operable, under the influence of said programming control structure, to enable (a) input scanning and memory capturing, as images, of the information contained in one or more selected promotional-content documents, and (b), thereafter, and under the control of said computer structure, displaying on said display screen the promotional contents of those documents.

2. The machine of claim 1, wherein said control structure and said software are constructed to collaborate in allowing a machine manager to perform one or more functions selected from the list including: (a) storing, as images, selected and scanned-in document contents; (b) displaying a list of stored images; (c) attaching an identifier to each stored image; (d) determining the display order of stored images; (e) deleting stored images at any time; (f) setting the respective start and stop times for each displayed image; (g) establishing the amount of memory space to make available for the storage of selected images; and (h) permitting a machine user to request, if the machine is equipped with a print engine, that the machine print a hard copy of a display image selected by the user.

3. The machine of claim 2, wherein said control structure and said software are further constructed to collaborate in allowing a machine manager to choose selected events as events which will trigger the display of captured images.

4. The machine of claim 3, wherein, in relation to users, said control structure and said software are additionally constructed to condition the machine to respond with a promotional display in a context-sensitive mode.

5. The machine claim of 4, wherein context sensitivity promotes a machine response to selected, specific content, such as words and/or images, present in user materials introduced to the machine by the user.

6. The machine of claims 1, 2, 3, or 4 which further includes a print engine and an associated printed-document output dispenser which dispenses printed documents, and wherein said control structure and said software are constructed to permit operative interaction between a machine user and a displayed image which results in one or both of (a) the computer structure creating and the print engine printing a related document, and the dispenser dispensing that document, and (b) the computer structure creating and the display screen displaying the related document.

7. In a scanning document machine having a display screen, performing the steps comprising
entering, by scanning, the promotional information content of a selected document,
selectively and programmably preparing that scan-entered promotional information for scheduled presentation on the machine's display screen, and
presenting the scheduled promotional information on the screen in accordance with the selected presentation schedule therefor.

8. In a scanning document machine having a display screen, performing the steps comprising,
entering, by scanning, the promotional information content of a selected document,
selectively preparing that scan-entered promotional information for presentation on the machine's display screen, and
presenting the prepared promotional information on the screen in a manner consistent with the selected preparation.

9. The method of claim 8, wherein selective preparation of promotional information includes one or more of selectable plural options drawn from the list including: (a) the overall time span(s) of presentation; (b) the individual presentation time spans of different, specific components of entered promotional information; (c) specific start and stop times associated with activities (a) and/or (b); and (d) the order of presentation of selected plural, different components of entered promotional information.

10. A manager-programmable, document-machine-based, point-of-activity promotional/informational display system for engaging a machine user comprising
a document machine including a document scanner, a memory, and programming controls operable to configure the operations of said scanner and said memory,
a display screen operatively associated with said scanner and said memory, and software installed in said machine enabling manager programming of the machine, via operation of said programming controls, to enable (a) selected scanner inputting, (b) memory acquiring, and (c) scheduled display-screen outputting of the information content in a document in relation to use of the machine by a point-of-activity user.

11. The system of claim 10, wherein said display screen forms part of said machine.

12. The system of claims 10 or 11, wherein said software enables manager configuring of said machine to create document-content displays that are context responsive in relation to user activity.
